(19) United States
(12) Patent Application Publication
(10) Pub. No.: US 2020/0059039 A1
(43) Pub. Date: Feb. 20, 2020

(54) LEVER TYPE CONNECTOR

(71) Applicant: Yazaki Corporation, Tokyo (JP)

(72) Inventor: Kazuto OHTAKA, Shizuoka (JP)

(73) Assignee: Yazaki Corporation, Tokyo (JP)

(21) Appl. No.: 16/540,588

(22) Filed: Aug. 14, 2019

(30) Foreign Application Priority Data
Aug. 17, 2018 (JP) 2018-153389

(51) Int. Cl. H01R 13/629

(52) U.S. Cl. CPC H01R 13/62938; B60R 16/0207; H01R 2201/26; H01R 13/62955

(57) ABSTRACT

A lever-type connector includes a housing fitted to and separated from a mating-connector housing, a lever supported by the housing and fits and separates the housings to and from each other through a rotation operation, and a cable cover mounted on the housing and covers a rear surface of the housing. A support shaft is provided in one of the housing and the lever, and a bearing portion having a shaft sliding groove is provided in the other one. A cam follower is provided in one of the lever and the mating-side connector, and a cam groove is provided in the other one. A guide protrusion is provided in one of the lever and the housing or the cable cover, and a guide groove is provided in the other one. The guide protrusion is provided closer to an operation portion of the lever than the support shaft during rotation operation.

### CROSS REFERENCE TO RELATED APPLICATION

This application is based upon and claims the benefit of priority from the prior Japanese Patent Application No. 2018-153389, filed on Aug. 17, 2018, the entire contents of which are incorporated herein by reference.

### BACKGROUND

### Technical Field

The disclosure relates to a lever type connector.

### Related Art

This type of lever type connector is disclosed in JP 1-11-3743 A and JP 2013-134810 A.

A lever type connector described in JP H11-3743 A includes a male housing and a lever. The male housing has a hood portion on the front side thereof and has a support shaft on both side surfaces thereof. The lever includes a female housing, a bearing hole, and a cam groove. The female housing has a fitting cylindrical portion having a rectangular tubular shape and externally fitted to the hood portion of the male housing and has a cam pin protruding from both side surfaces of the fitting cylindrical portion. The bearing hole is formed such that guide grooves fitted to the support shaft are formed in a pair of arm portions extending from both ends of an operation portion. The cam pin engages with the cam groove.

In addition, when the lever is rotated through a pressing operation of the operation portion, the guide groove and the cam groove of the lever slide along the support shaft and the cam pin, a rotational operation force of the operation portion is amplified and transmitted to an engagement portion between the cam groove and the cam pin due to leverage centering on the support shaft, both male and female housings are drawn due to a cam action, and both the male and female housings are set to be in a regular fitting state when the lever reaches a rotation completion position.

However, in the lever type connector described in JP H11-3743 A, the support shaft and the cam pin during sliding are located at a position separated from the operation portion of the lever, and a difference between a distance between the support shaft and the operation portion and a distance between the support shaft and the cam pin is large. Therefore, leverage acts at the time of sliding the lever so as to be inclined with respect to the guide groove and the cam groove, and a load equal to or greater than the lever operation force is applied to an abutting portion between the cam groove and the cam pin, which leads to a concern that the support shaft or the lever may be damaged.

### SUMMARY

The disclosure is directed to a lever type connector in which a support shaft and a lever can be reliably prevented from being damaged.

A lever type connector according to an embodiment includes a housing fitted to and separated from a mating-side connector housing, a lever rotatably and slidably supported by the housing and configured to fit and separate the housing and the mating-side connector housing to and from each other through a rotation operation, and a cable cover mounted on the housing and covers a rear surface of the housing. A support shaft is provided in any one of the housing and the lever, and a bearing portion having a shaft sliding groove in which the support shaft slides is provided in the other one, and a cam follower is provided in any one of the lever and the mating-side connector, and a cam groove engaging with the cam follower is provided in the other one. Guide protrusions are provided in any one of the lever and the housing or the cable cover, and a guide groove engaging with the guide protrusion is provided in the other one. The guide protrusions are provided closer to an operation portion of the lever than the support shaft during rotation of the lever.

According to the above-described configuration, a guide protrusion is provided on an operation portion of a lever, and thus it is possible to reliably prevent a support shaft and the lever from being damaged by inhibiting leverage even when the lever is slid in a direction in which the lever is inclined in a sliding direction. In addition, the guide protrusion is provided on the operation portion of the lever, and thus it is possible to achieve reductions in the size and weight of the guide protrusion by inhibiting leverage.

### BRIEF DESCRIPTION OF DRAWINGS

FIG. 1 is a perspective view illustrating a state before a lever type connector according to an embodiment is fitted;

FIG. 2 is an exploded perspective view of the lever type connector;

FIG. 3 is a perspective view of a male housing of the lever type connector;

FIG. 4 is a perspective view of a lever of the lever type connector;

FIG. 5 is a side view illustrating a temporary locking state of the lever;

FIG. 6 is a cross-sectional view taken along line VI-VI in FIG. 5;

FIG. 7 is a side view illustrating a complete locking state of the lever;

FIG. 8 is a cross-sectional view taken along line VIII-VIII in FIG. 7;

FIG. 9A is a perspective view illustrating a procedure of attaching the lever type connector to a vehicle body panel;

FIG. 9B is a perspective view illustrating a procedure of attaching the lever type connector to a vehicle body panel;

FIG. 9C is a perspective view illustrating a procedure of attaching the lever type connector to a vehicle body panel;

FIG. 9D is a perspective view illustrating a procedure of attaching the lever type connector to a vehicle body panel;

FIG. 9E is a perspective view illustrating a procedure of attaching the lever type connector to a vehicle body panel;

FIG. 10 is a side view illustrating a positional relationship between an attachment hole of a vehicle body panel and the lever before the lever slides;

FIG. 11 is a side view illustrating a state where the lever slides and is attached to the attachment hole of the vehicle body panel;

FIG. 12A is a side view illustrating a procedure of separating both housings of the lever type connector from each other;

FIG. 12B is a side view illustrating a procedure of separating both housings of the lever type connector from each other;

FIG. 12C is a side view illustrating a procedure of separating both housings of the lever type connector from each other; and

FIG. 13 is a side view illustrating a state where the lever type connector is attached to the vehicle body panel in a partial cross-section.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for embodiments of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

Hereinafter, an embodiment of the present invention will be described with reference to the drawings.

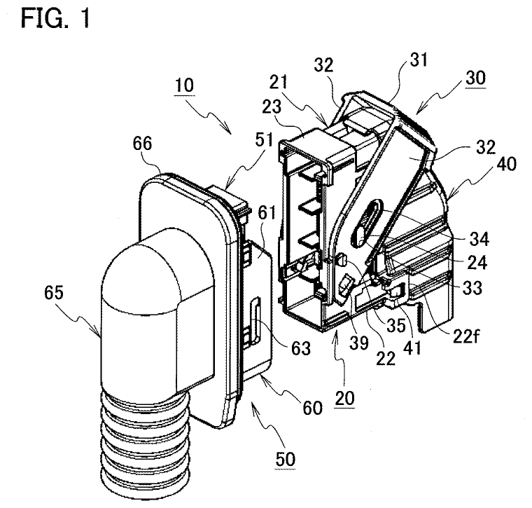

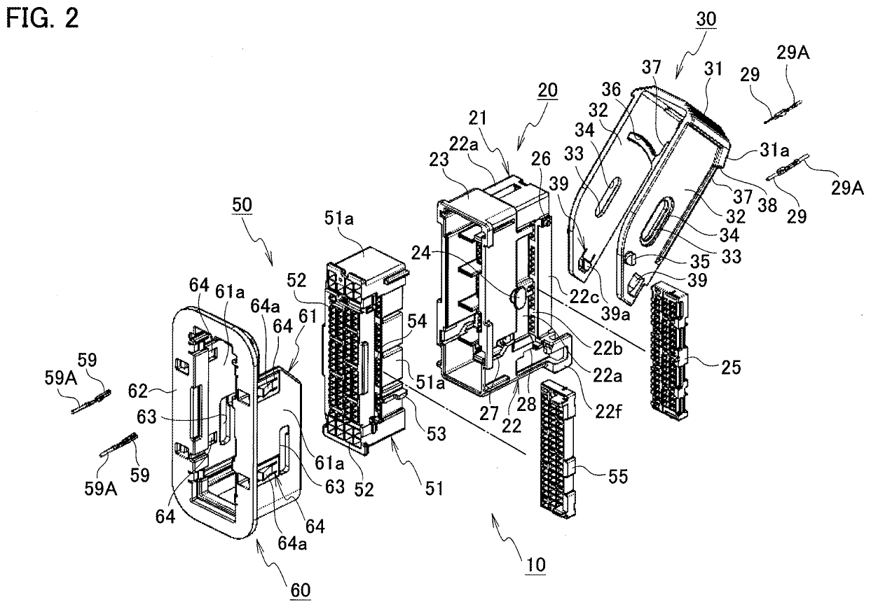

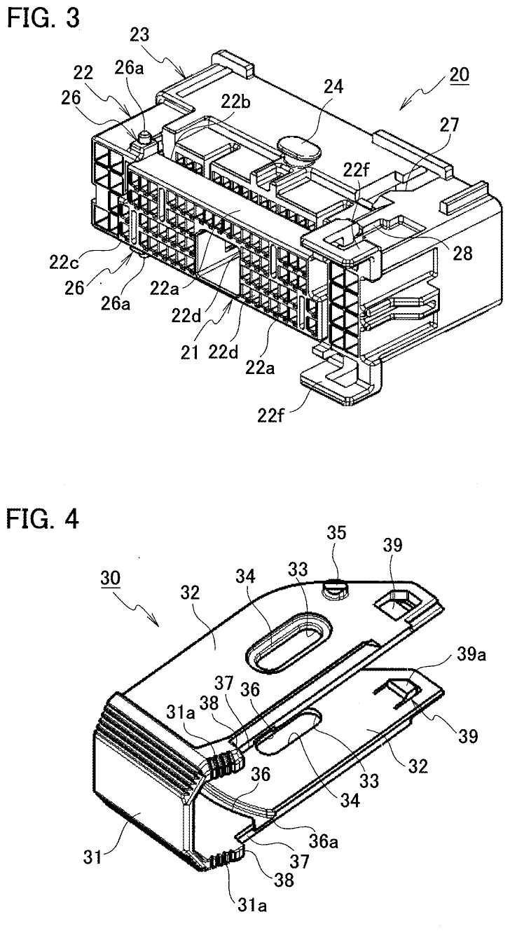

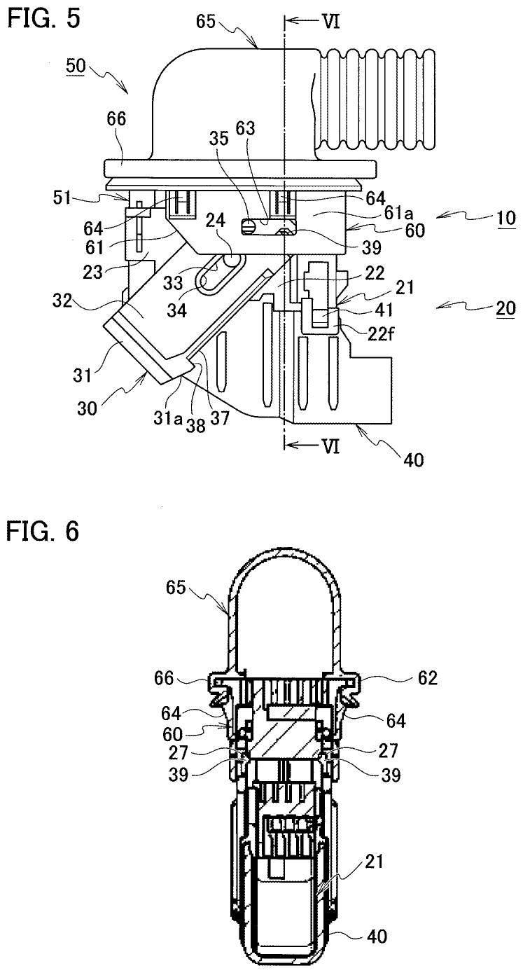

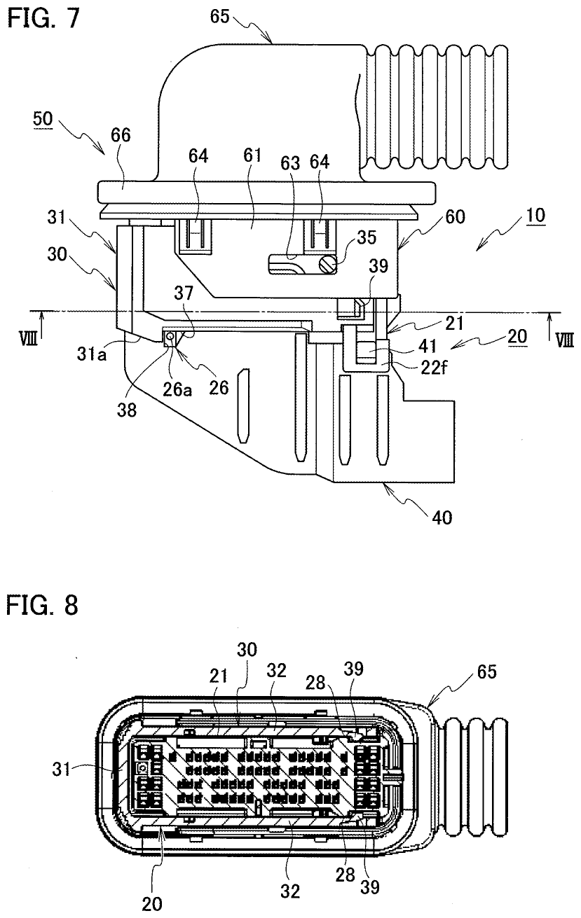

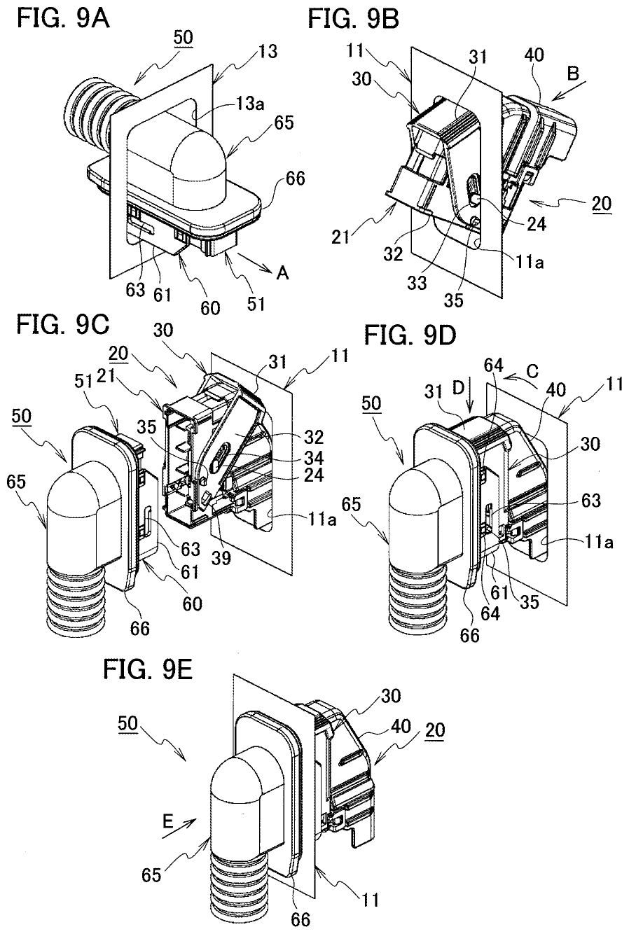

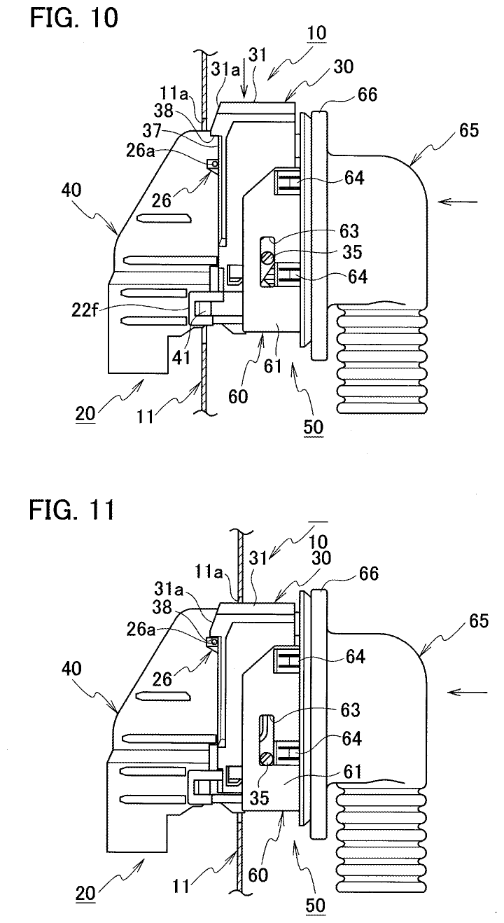

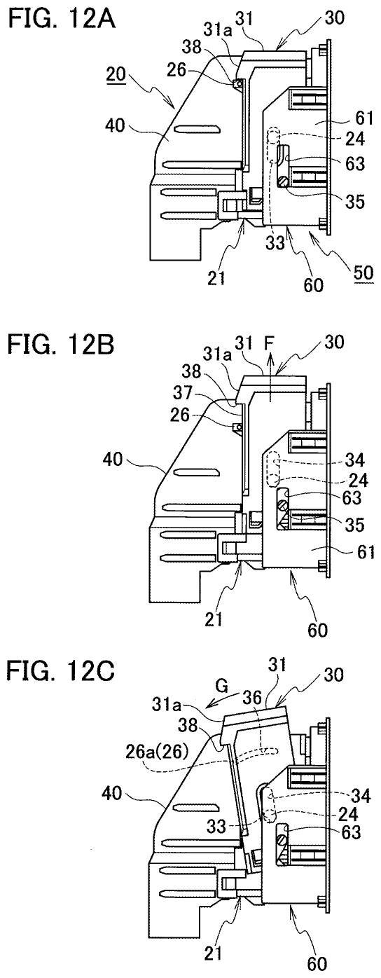

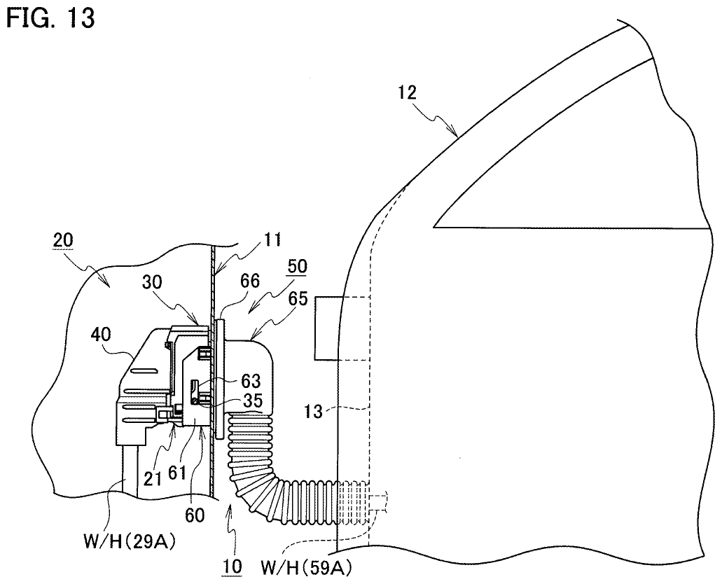

FIG. 1 is a perspective view illustrating a state before a lever type connector according to an embodiment of the present invention is fitted, FIG. 2 is an exploded perspective view of the lever type connector, FIG. 3 is a perspective view of a male housing of the lever type connector, FIG. 4 is a perspective view of a lever of the lever type connector, FIG. 5 is a side view illustrating a temporary locking state of the lever, FIG. 6 is a cross-sectional view taken along line Y-Y in FIG. 5, FIG. 7 is a side view illustrating a complete locking state of the lever, FIG. 8 is a cross-sectional view taken along line X-X in FIG. 7, FIGS. 9A to 9E are perspective views illustrating a procedure of attaching the lever type connector to a vehicle body panel, FIG. 10 is a side view illustrating a positional relationship between an attachment hole of a vehicle body panel and the lever before the lever slides, FIG. 11 is a side view illustrating a state where the lever is attached to the attachment hole of the vehicle body panel while sliding, FIGS. 12A to 12C are side views illustrating a procedure of separating both housings of the lever type connector from each other, and FIG. 13 is a side view illustrating a state where the lever type connector is attached to the vehicle body panel in a partial cross-section.

As illustrated in FIGS. 1 and 13, a lever type connector 10 includes a male connector 20 on a side of a vehicle body panel 11 and a female connector (mating-side connector) 50 on a side of a door 12.

As illustrated in FIG. 2, the male connector 20 includes a male housing (housing) 21, a lever 30 formed of a synthetic resin, and a cable cover 40 formed of a synthetic resin. The male housing 21 accommodates a plurality of male terminals (terminals) 29 and is fitted to and separated from a female housing (a housing of a mating-side connector) 51 of the female connector 50. The lever 30 is rotatably and slidably supported by the male housing 21 through a support shaft 24 and is fitted to and separated from both the male and female housings 21 and 51 through a rotation operation. The cable cover 40 is mounted so as to cover a rear surface 22c of the male housing 21.

In addition, the female connector 50 includes a female housing 51 formed of a synthetic resin, a frame 60 formed of a synthetic resin and having a tubular rectangular frame shape, and a grommet 65 formed of rubber. The female housing 51 accommodates a plurality of female terminals (terminals) 59 and is fitted to and separated from the male housing 21 of the male connector 20. The frame 60 is fitted into the outer periphery of the female housing 51 and is locked to an attachment hole 11a of the vehicle body panel 11. The grommet 65 is mounted on a flange portion 62 of the frame 60.

As illustrated in FIGS. 2 and 3, the male housing 21 includes a housing body 22 having a rectangular block shape and a hood portion 23. The housing body 22 has a terminal accommodation hole 22d in which the male terminal 29 is accommodated. The hood portion 23 is integrally formed to protrude on the front side of the housing body 22 and has the female housing 51 fitted thereinto. The support shaft 24 extending in a direction perpendicular to a fitting direction is formed to integrally protrude at boundaries between the central hood portion 23 and both the side surfaces 22a and 22a of the housing body 22.

In addition, an opening 22b is formed in one side surface 22a of the housing body 22. A side retainer 25 configured to lock the male terminal 29 is fitted into the opening 22b. Further, guide protrusions 26 are respectively integrally formed to protrude at positions close to an operation portion 31 of the lever 30 which is to be described later on the rear surface 22c of both the side surfaces 22a and 22a of the housing body 22. That is, the guide protrusion 26 is provided closer to the operation portion 31 of the lever 30 than the support shaft 24 during the rotation of the lever 30, as illustrated in FIG. 12C. In addition, top portions 26a of the respective guide protrusions 26 are set to be positioned further inside in a vertical direction than a sliding portion 37 and an abutting portion 38 of the lever 30 which is to be described later.

Further, a temporary locking concave portion (temporary locked portion) 27 and a complete locking concave portion (complete locked portion) 28 are respectively formed at positions of the hood portion 23 and both the side surfaces 22a and 22a of the housing body 22 which correspond to a rotation track of a protrusion portion 39a of a locking arm (locking portion) 39 of the lever 30 which is to be described later. In addition, a frame-shaped lock portion 22f configured to perform locking by being locked to a locking protrusion 41 of the cable cover 40 formed to cover the rear surface 22c of the housing body 22 is integrally formed to protrude at positions closer to the complete locking concave portions 28 on both the side surfaces 22a and 22a of the housing body 22.

As illustrated in FIGS. 1, 2, and 4, the lever 30 includes the operation portion 31 and a pair of arm portions 32 and 32 extending from both sides of the operation portion 31.

A tapered portion 31a is formed on the cable cover 40 of the operation portion 31 of the lever 30. In addition, as illustrated in FIG. 10, when both the male and female housings 21 and 51 are fitted and are then assembled to the attachment hole 11a of the vehicle body panel 11, the tapered portion 31a is pressed against an end face of the attachment hole 11a so that the lever 30 is slid to a regular position as illustrated in FIG. 11. That is, a state where both the male and female housings 21 and 51 can be assembled to the vehicle body panel 11 is detected depending on whether or not the lever 30 is slidable.

As illustrated in FIGS. 1, 2, and 4, a bearing hole (bearing portion) 33 having a shaft sliding groove 34 in which the support shaft 24 slides is formed at the center of the arm portion 32 of the lever 30. In addition, a pin-shaped cam follower 35 is integrally formed to protrude in the arm portion 32. Further, an arc-shaped guide groove 36 engaging with the guide protrusion 26 is formed between the operation portion 31 and the bearing hole 33 of the arm portion 32. The guide groove 36 is formed in an elongated arc shape centered on the support shaft 24, and a pick-up tapered portion 36a configured to guide the guide protrusion 26 is formed on a side of an open end thereof.

In addition, as illustrated in FIG. 4, the arm portion 32 of the lever 30 is provided with the sliding portion 37 on which the guide protrusion 26 slides in a sliding direction after the rotation of the lever 30. The sliding portion 37 is formed in a rail shape in which the inside is recessed. Further, the arm portion 32 is provided with the abutting portion 38 on which the guide protrusion 26 abuts at a slide terminus after the rotation of the lever 30. In addition, after both the male and female housings 21 and 51 are fitted through a rotation operation of the lever 30, the guide protrusion 26 slides until the guide protrusion touches the abutting portion 38 along the sliding portion 37, and thus the lever 30 slides with respect to the male housing 21.

Further, the locking arm (locking portion) 39 elastically deformed in a direction perpendicular to a fitting direction is integrally formed on the outer side of a tip end of the arm portion 32 of the lever 30, and the protrusion portion 39a of the locking arm 39 is locked to or separated from the temporary locking concave portion 27 and the complete locking concave portion 28. That is, the locking arm 39 is also used to be locked to and separated from the temporary locking concave portion 27 and the complete locking concave portion 28.

As illustrated in FIG. 2, the female housing 51 is formed in a rectangular block shape having a terminal accommodation chamber 52 in which the female terminal 59 is accommodated, and release protrusions (release portions) 53 configured to release a temporary locking state between the protrusion portion 39a of the locking arm 39 of the lever 30 and the temporary locking concave portion 27 are respectively integrally formed to protrude at positions on both side surfaces 51a and 51a which face the temporary locking concave portions 27 on both the side surfaces 22a and 22a of the male housing 21.

In addition, an opening 54 is formed in one side surface 51a of the female housing 51. A side retainer 55 configured to lock the female terminal 59 is fitted into the opening 54.

The frame 60 includes a square cylindrical frame body 61 of which the upper surface is open and a frame plate-shaped flange portion 62 which is integrally formed in the frame body 61.

A cam groove 63 engaging with the cam follower 35 of the lever 30 is formed in each of both side walls 61a and 61a of the frame body 61. In addition, elastically deformable panel locking arms 64 locked to the attachment hole 11a of the vehicle body panel 11 are respectively integrally formed at positions of both the side walls 61a and 61a of the frame body 61 which are close to the flange portion 62. In addition, a peripheral edge of the attachment hole 11a of the vehicle body panel 11 is locked between the protrusion portion 64a of the panel locking arm 64 and the flange portion 62. Further, a recessed groove-shaped water stop portion 66 of the grommet 65 is fitted into the flange portion 62.

In addition, as illustrated in FIGS. 2 and 13, a cable 29A is connected to the male terminal 29, and a wire harness W/H is constituted by a bundle of a plurality of cables 29A. In addition, a cable 59A is connected to the female terminal 59, and a wire harness W/H is constituted by a bundle of a plurality of cables 59A.

According to the lever type connector 10 of the above-described embodiment, when the lever type connector 10 is assembled to the attachment hole 11a of the vehicle body panel 11, first, the female connector 50 having the grommet 65 mounted on the frame 60 is made to pass through a through hole 13a of a door panel 13 as indicated by an arrow A in FIG. 9A. In addition, as indicated by an arrow B in FIG. 9B, the male connector 20 having the lever 30 set to be in a temporary locking state is made to pass through the attachment hole 11a of the vehicle body panel 11. In a case where the lever 30 is set to be in a temporary locking state with respect to the male housing 21, the protrusion portion 39a of the locking arm 39 of the lever 30 is temporarily locked to the temporary locking concave portion 27 of the male housing 21 as illustrated in FIGS. 5 and 6, and thus the lever 30 cannot be rotated in a fitting direction of both the male and female housings 21 and 51. From this state, when the female housing 51 is pushed into the hood portion 23 of the male housing 21, the release protrusion 53 of the female housing 51 elastically deforms the locking arm 39 of the lever 30 outward, so that a temporary locking state between the temporary locking concave portion 27 of the male housing 21 and the protrusion portion 39a of the locking arm 39 of the lever 30 is released, and thus the lever 30 cannot be rotated in a fitting direction of both the male and female housings 21 and 51.

Next, as illustrated in FIG. 9C, the male housing 21 of the male connector 20 and the female housing 51 of the female connector 50 are made to face each other, and the cam follower 35 of the lever 30 is inserted into the cam groove 63 of the frame 60 of the female connector 50 from the inside to engage therewith.

In addition, as indicated by an arrow C in FIG. 9D, the lever 30 is rotated to complete fitting between the male housing 21 of the male connector 20 and the female housing 51 of the female connector 50.

In this case, the arc-shaped guide groove 36 of the lever 30 moves along the guide protrusion 26 of the male housing 21 in a state where the bearing hole 33 of the lever 30 slidably comes into contact with the support shaft 24 of the male housing 21, so that the lever 30 is rotated. When the rotation of the lever 30 is terminated, the guide protrusion 26 of the male housing 21 deviates from the pick-up tapered portion 36a which is an open end of the arc-shaped guide groove 36 of the lever 30, so that the lever 30 is set to be in a slidable state with respect to the male housing 21.

Thereafter, as indicated by an arrow D in FIG. 9D, the lever 30 is slid along the guide protrusion 26 of the male housing 21 by pushing the operation portion 31 of the lever 30, so that the protrusion portion 39a of the locking arm 39 of the lever 30 is locked to the complete locking concave portion 28 of the male housing 21 as illustrated in FIGS. 7 and 8. During the sliding of the lever 30, the shaft sliding groove 34 of the lever 30 slidably comes into contact with the support shaft 24 of the male housing 21.

When the lever 30 is slid along the guide protrusion 26 of the male housing 21, the guide protrusion 26 of the male housing 21 is provided in the vicinity of the tapered portion 31a of the operation portion 31 of the lever 30 as illustrated in FIG. 12B. Therefore, even when the lever 30 is slid in a direction in which the lever is inclined with respect to the shaft sliding groove 34 and the arc-shaped guide groove 36, it is possible to reliably prevent the support shaft 24 of the male housing 21 and the lever 30 from being damaged by inhibiting leverage. In addition, the guide protrusion 26 is provided in the vicinity of the operation portion 31 so as to be used (shared) for both the rotation and sliding of the lever 30, and thus it is possible to achieve reductions in the size and weight of the guide protrusion 26 by inhibiting leverage. Further, the top portions 26a of the guide protrusions 26 are set to be positioned further inside in a vertical direction than the sliding portion 37 and the abutting portion 38 of the lever 30 so as not to protrude outward from the arm portions 32, and thus it is also possible to reliably prevent the guide protrusions 26 from being damaged during the assembling of a vehicle body using the lever 30 which is to be described later.

In addition, as indicated by an arrow E in FIG. 9E, the female connector 50 for which an operation using the operation portion 31 of the lever 30 has been completed is pushed into the attachment hole 11a of the vehicle body panel 11, the protrusion portion 64a of the panel locking arm 64 provided in the frame 60 of the female connector 50 is locked to the peripheral edge of the attachment hole 11a of the vehicle body panel 11, and a state where the water stop portion 66 of the grommet 65 is pushed against the vehicle body panel 11 is maintained, so that water is prevented from being infiltrated from the attachment hole 11a of the vehicle body panel 11.

As illustrated in FIGS. 10 and 11, in a case where the lever 30 does not slide to a regular position (a position where the abutting portion 38 of the arm portion 32 of the lever 30 touches the guide protrusion 26 of the male housing 21) of the male housing 21 (a case where a sliding amount of the lever 30 is slightly insufficient is also included) at the time of pushing both the male and female housings 21 and 51 set to be in a complete fitting state into the vehicle body panel 11 to assemble the male and female housings to the attachment hole 11a, the tapered portion 31a of the operation portion 31 of the lever 30 is pressed against an edge end face of the attachment hole 11a, so that the lever 30 forcibly slides to the regular position. Accordingly, as illustrated in FIG. 9E and FIG. 11, it is possible to simply and reliably assemble only the male and female housings 21 and 51 set to be in a complete fitting state to the vehicle body panel 11 by making the lever 30 slide to the regular position of the male housing 21, and it is possible to detect an abnormality due to the male and female housings incapable of being assembled to the vehicle body panel 11 in a case where the lever 30 does not slide to the regular position. In this manner, it is possible to simply and reliably detect a state where the lever type connector 10 can be assembled to the attachment hole 11a of the vehicle body panel 11 depending on whether or not the lever 30 is slidable, that is, by detecting the position of the lever 30 with respect to the vehicle body panel 11.

As illustrated in FIGS. 12A and 12B, in a case where the male housing 21 of the male connector 20 and the female housing 51 of the female connector 50 which are fitted to each other are separated from each other, it is possible to accommodate the guide protrusion 26 of the male housing 21 from the pick-up tapered portion 36a which is an open end of the arc-shaped guide groove 36 of the lever 30 by moving the lever 30 to a slidable position as indicated by an arrow F in FIG. 12B from a state before the lever 30 slides before the separation of both the male and female housings 21 and 51 as illustrated in FIG. 12A and then it is possible to smoothly rotate the lever 30 with respect to the male housing 21 as indicated by an arrow G in FIG. 12C, thereby making it possible to separate both the male and female housings 21 and 51 from each other. Similar to the rotation and sliding of the lever 30 at the time of the above-described fitting, when both the male and female housings 21 and 51 are separated from each other, it is also possible to reliably prevent the support shaft 24 and the guide protrusion 26 of the male housing 21 and the lever 30 from being damaged.

In this manner, when the male housing 21 of the male connector 20 and the female housing 51 of the female connector 50 are fitted to and separated from each other, the locking arm 39 of the lever 30 is also used to be locked to and separated from the temporary locking concave portion 27 and the complete locking concave portion 28 of the male housing 21, respectively, and dedicated locking arms to be respectively used for temporary locking and complete locking are not required on the lever 30. Therefore, it is possible to avoid a reduction in the strength of the lever 30 due to the locking arm 39 being provided at a plurality of positions of the pair of arm portions 32 and 32 of the lever 30 as in the related art and to avoid an increase in the size of the lever 30. Consequently, it is possible to reduce a fitting force of the lever type connector 10 having a larger number of poles (the number of terminals) without increasing the overall size of the connector.

In addition, according to the embodiment, a support shaft is provided in a male housing, and a bearing portion having a shaft sliding groove in which the support shaft slides is provided in a lever. However, the support shaft may be provided in the lever, and the bearing portion having the shaft sliding groove in which the support shaft slides may be provided in the male housing.

In addition, according to the embodiment, a cam follower is provided in the lever, and a cam groove engaging with the cam follower is provided in a frame of a female connector. However, the cam follower may be provided in the frame or a female housing of the female connector, and the cam groove engaging with the cam follower may be provided in the lever.

Further, according to the embodiment, a guide protrusion is provided in the male housing, and a guide groove engaging with the guide protrusion is provided in the lever. However, the guide protrusion may be provided in the lever, and the guide groove engaging with the guide protrusion may be provided in the male housing or a cable cover.

Further, according to the embodiment, the female connector is constituted by the female housing and the frame having a flange portion and a panel locking arm attached to a vehicle body panel, and the cam groove is formed in the frame. However, the female connector may be constituted by the female housing having the flange portion and the panel locking arm attached to the vehicle body panel, and the cam groove may be formed in the female housing.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes, which come within the meaning and range of equivalency of the claims, are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. A lever type connector comprising:
a housing fitted to and separated from a mating-side connector housing on a front side of the housing;
a lever rotatably and slidably supported by the housing and configured to fit and separate the housing and the mating-side connector housing to and from each other through a rotation operation; and
a cable cover mounted on the housing and covers a rear surface of the housing,
wherein a support shaft is provided in any one of the housing and the lever, and a bearing portion having a shaft sliding groove in which the support shaft slides is provided in the other one,
a cam follower is provided in any one of the lever and the mating-side connector, and a cam groove engaging with the cam follower is provided in the other one,
a guide protrusion is provided in any one of the lever and the housing or the cable cover, and a guide groove engaging with the guide protrusion is provided in the other one, and
the guide protrusion is provided closer to an operation portion of the lever than the support shaft during rotation of the lever.

2. The lever type connector according to claim 1, wherein
a sliding portion on which the guide protrusion slides in a sliding direction after the rotation of the lever is provided in the other one of the lever and the housing or the cable cover.

3. The lever type connector according to claim 2, wherein
an abutting portion on which the guide protrusion abuts at a slide terminus after the rotation of the lever is further provided in the other one of the lever and the housing or the cable cover, and
a top portion of the guide protrusion is set further inside in a vertical direction than the sliding portion and the abutting portion.

4. The lever type connector according to claim 1, wherein
the guide groove is provided in an arc shape centered on the support shaft.
